(19) United States
(12) Patent Application Publication
(10) Pub. No.: US 2025/0201464 A1
(43) Pub. Date: Jun. 19, 2025

(54) INDUCTOR DEVICES AND FORMING METHODS THEREOF

(71) Applicant: EAGLERISE INTELLIGENT DEVICE CORPORATION LTD., Foshan (CN)

(72) Inventors: Nannan Zhao, Foshan (CN); Yinglin Wang, Foshan (CN); Guoquan Li, Foshan (CN); Baoqing Ren, Foshan (CN); Fuming Liu, Foshan (CN)

(21) Appl. No.: 18/945,174

(22) Filed: Nov. 12, 2024

(30) Foreign Application Priority Data
Dec. 18, 2023 (CN) 202311738412.0

(51) Int. Cl. H01F 27/02; H01F 27/22; H01F 27/26; H01F 27/28; H01F 27/30; H01F 41/00; H01F 41/06

(52) U.S. Cl. CPC H01F 27/022; H01F 27/266; H01F 27/306; H01F 41/005; H01F 41/06; H01F 27/22; H01F 27/2876

(57) ABSTRACT

The present disclosure relates to the field of inductor, specifically to an inductor device and a forming method therefor. The injection-molded body of the inductor device is formed through multiple injection molding steps. The first inductor coil and the first magnetic core column are fixed together in advance, and the injection pressure required for the first injection-molded body is lower than that for the entire inductor device. Similarly, the magnetic yoke column also experiences reduced injection pressure. Finally, when fixing the first assembly and the magnetic yoke column assembly in place by the inductor injection-molded body, due to the first injection-molded body having already fixed first magnetic core column and the first inductor coil, the overall anti-pressure ability of the first assembly is higher, enabling it to withstand greater injection pressure, resulting in a higher yield rate for the inductor device.

### CROSS REFERENCE TO RELATED APPLICATIONS

The present application claims the benefit of Chinese Patent Application No. 202311738412.0 filed on Dec. 18, 2023, the contents of which are incorporated herein by reference in their entirety.

### TECHNICAL FIELD

The present disclosure relates to the field of inductor, in particular to inductor devices and forming methods thereof.

### BACKGROUND OF THE INVENTION

High-power inductor devices for automotive use at present are typically encapsulated with thermally conductive silicone gel, which secures the inductor coil and magnetic core in place while also conducting the heat generated by them. However, the encapsulation process for these inductor devices is relatively complex, resulting in low efficiency for forming inductor devices. In order to improve forming efficiency, injection molding methods have also been adopted for manufacturing inductors. Due to the complicated structure of inductor devices and the small gaps between the coil and the internal magnetic core, a high injection pressure is required to ensure adequate filling of the molding material fluid. During the injection molding process, the magnetic core is susceptible to damage under the high pressure, resulting in a low yield rate for the inductors.

### SUMMARY OF THE INVENTION

The present invention provides a forming method for an inductor device to address the technical issue of low yield rates in inductor devices currently produced using existing injection molding methods.

Additionally, another objective of the present disclosure is to provide inductor devices.

According to a first aspect of the present disclosure, an inductor device providing in some embodiments may include:
a first assembly comprising a first inductor coil, a first magnetic core column and a first injection-molded body, with the first inductor coil wound around an outer perimeter of the first magnetic core column, the first inductor coil and the first magnetic core column secured in place by the first injection-molded body, and at least a part of the first injection-molded body filling a gap between the first inductor coil and the first magnetic core column;
a magnetic yoke column assembly comprising a magnetic yoke column and a magnetic yoke column injection-molded body that is injection-molded onto the magnetic yoke column, with the magnetic yoke column injection-molded body having a first assembly positioning structure for positioning the first assembly;
an inductor injection-molded body, and
an end magnetic yoke that is arranged at an end of the magnetic yoke column,
wherein a magnetic circuit between the first magnetic core column and the magnetic yoke column is conducted through the end magnetic yoke; the inductor injection-molded body is formed after the first injection-molded body and the magnetic yoke column injection-molded body are injection-molded, and the inductor injection-molded body fixes the first assembly and the magnetic yoke column assembly in place.

Further, in some embodiments, the inductor device may further include a second assembly comprising a second inductor coil, a second magnetic core column and a second injection-molded body, with the second inductor coil wound around an outer perimeter of the second magnetic core column, the second inductor coil and the second magnetic core column being fixed in place by the second injection-molded body, and at least a part of the second injection-molded body filling a gap between the second inductor coil and the second magnetic core column;
wherein the magnetic yoke column injection-molded body may have a second assembly positioning structure for positioning the second assembly; the inductor injection-molded body may be formed after the second injection-molded body is injection-molded, and the inductor injection-molded body may fix the first assembly, the second assembly and the magnetic yoke column assembly in place.

Further, in some embodiments, the first magnetic core column and the second magnetic core column may be arranged along a first direction, and the first magnetic core column and the magnetic yoke column may be arranged along a second direction, with an angle between the first direction and the second direction being greater than 0 degrees.

Further, in some embodiments, an end of the first magnetic core column, an end of the second magnetic core column and an end of the magnetic yoke column may be all magnetically connected to the end magnetic yoke; and the end magnetic yoke may comprise a first magnetic core column conducting surface, a second magnetic core column conducting surface and a magnetic yoke column conducting surface, with the first magnetic core column conducting surface being perpendicular to the magnetic yoke column conducting surface, and the first magnetic core column conducting surface and the second magnetic core column conducting surface being arranged at the same side of the end magnetic yoke.

Further, in some embodiments, the inductor device may comprise a pre-positioning member; and before the inductor injection-molded body fixes the first assembly and the second assembly, the pre-positioning member may pre-position the first assembly and the second assembly.

Further, in some embodiments, the inductor injection-molded body may comprise a first inductor injection-molded body and a second inductor injection-molded body that are spaced apart along an extension direction of the magnetic yoke column, with the first inductor injection-molded body being injection-molded on one end of the magnetic yoke column and the second inductor injection-molded body on the other end of the magnetic yoke column.

Further, in some embodiments, the first inductor injection-molded body may comprise a surface portion covering an outer surface of the end magnetic yoke and an inner portion arranged at a side of the end magnetic yoke facing the first magnetic core column, with the inner portion being connected onto the surface portion; and in an extension direction of the first magnetic core column, at least a part of the inner portion may be arranged between the first injection-molded body and the end magnetic yoke.

Further, in some embodiments, the inductor device may further comprise a first terminal conducting bar connected to the first inductor coil, with a part of the inductor injection-molded body being injection-molded onto the first terminal conducting bar.

According to a second aspect of the present disclosure, a forming method for an inductor device providing in some embodiments may include:
winding a first inductor coil of an inductor device around an outer perimeter of a first magnetic core column, fixing the first magnetic core column and the first inductor coil in place by injection-molding a first injection-molded body, and filling at least a part of the first injection-molded body into a gap between the first magnetic core column and the first inductor coil to prepare a first assembly;
injection-molding a magnetic yoke column injection-molded body on a magnetic yoke column of the inductor device, and forming a first assembly positioning structure on the magnetic yoke column injection-molded body to prepare a magnetic yoke column assembly; and
positioning and assembling the first assembly and the magnetic yoke column assembly to position the first assembly and the first assembly positioning structure, and fixing the first assembly and the magnetic yoke column assembly together by injection-molding the inductor injection-molded body.

Further, in some embodiments, the method may further include: winding a second inductor coil of the inductor device around an outer perimeter of a second magnetic core column, fixing the second magnetic core column and the second inductor coil in place by injection-molding a second injection-molded body, and filling at least a part of the second injection-molded body into a gap between the second magnetic core column and the second inductor coil to prepare a second assembly;
wherein the preparation of the magnetic yoke column assembly may further comprise: forming a second assembly positioning structure on the magnetic yoke column injection-molded body;
before injection-molding the inductor injection-molded body, the method may further comprise: positioning and assembling the second assembly and the magnetic yoke column assembly to position the second assembly and the second assembly positioning structure; and
after injection-molding the inductor injection-molded body, the first assembly, the second assembly and the magnetic yoke column assembly may be fixed together by the inductor injection-molded body.

According to the inductor device disclosed in the aforementioned embodiments, the injection-molded body of the inductor device is formed through multiple injection molding steps. Initially, the first inductor coil and the first magnetic core column are fixed together in advance, and the injection pressure required for the first injection-molded body is lower than that for the entire inductor device, thereby exerting less pressure on the first magnetic core, making it less prone to damage and improving the yield rate of the inductor device. Similarly, the magnetic yoke column also experiences reduced injection pressure, and the first assembly positioning structure formed on the magnetic yoke column injection-molded body facilitates the assembly of the two, enhancing the injection molding of the inductor device. Finally, when fixing the first assembly and the magnetic yoke column assembly in place by the inductor injection-molded body, due to the first injection-molded body having already fixed first magnetic core column and the first inductor coil in place, the overall anti-pressure ability of the first assembly is higher, enabling it to withstand greater injection pressure, resulting in a higher yield rate for the inductor device.

### BRIEF DESCRIPTION OF THE DRAWINGS

FIG. 1 is a schematic structural diagram of an inductor device in some embodiments;

FIG. 2 is another schematic structural diagram of an inductor device in some embodiments;

FIG. 3 is a schematic structural diagram of an inductor device assembled with a thermal pad in some embodiments;

FIG. 4 is a sectional view of an inductor device in some embodiments;

FIG. 5 is another sectional view of an inductor device in some embodiments;

FIG. 6 is yet another sectional view of an inductor device in some embodiments;

FIG. 7 is a schematic structural diagram of an inductor device without an inductor injection-molded body in some embodiments;

FIG. 8 is another schematic structural diagram of an inductor device without an inductor injection-molded body in some embodiments;

FIG. 9 is a schematic structural diagram of a magnetic yoke column assembly in some embodiments;

FIG. 10 is an exploded view of a first assembly, a second assembly and a pre-positioning member in some embodiments;

FIG. 11 is a schematic structural diagram of a first inductor injection-molded body in some embodiments;

FIG. 12 is a schematic structural diagram of a second inductor device assembled with a thermal pad in some embodiments;

FIG. 13 is a schematic structural diagram of a second inductor device in some embodiments;

FIG. 14 is another schematic structural diagram of a second inductor device in some embodiments;

FIG. 15 is a sectional view of a second inductor device in some embodiments;

FIG. 16 is a schematic structural diagram of a second inductor device without an inductor injection-molded body in some embodiments;

FIG. 17 is a schematic structural diagram of a second inductor device without an inductor injection-molded body and an end magnetic yoke in some embodiments;

FIG. 18 is a schematic structural diagram of a magnetic yoke column assembly of a second inductor device in some embodiments;

FIG. 19 is a schematic structural diagram of a second inductor injection-molded body of a second inductor device in some embodiments; and

FIG. 20 is a schematic structural diagram of a magnetic yoke column and an end magnetic yoke in some embodiments.

List of feature names corresponding to the reference numerals in the accompanying figures:
1 first assembly
11 first inductor coil
12 first magnetic core column
121 magnetic core block
122 ceramic plate
13 first injection-molded body
2 magnetic yoke column assembly
21 magnetic yoke column
211 first column
212 second column
213 column spacing
22 magnetic yoke column injection-molded body
221 first assembly positioning structure
2211 first positioning slot
222 second assembly positioning structure
2221 second positioning slot
223 insert positioning structure
224 first side plate
225 second side plate
226 first end plate
227 second end plate
228 base plate
3 inductor injection-molded body
31 first inductor injection-molded body
311 surface portion
312 inner portion
3121 first inner portion
3122 second inner portion
32 second inductor injection-molded body
33 extrusion protrusion
321 conducting bar injection-molded part
4 end magnetic yoke
41 first magnetic core column conducting surface
42 second magnetic core column conducting surface
43 magnetic yoke column conducting surface
44 first end magnetic yoke surface
45 second end magnetic yoke surface
46 third end magnetic yoke surface
47 fourth end magnetic yoke surface
48 chamfer
5 second assembly
51 second inductor coil
52 second magnetic core column
53 second injection-molded body
6 inductor lead wire
61 terminal conducting bar
611 first terminal conducting bar
7 mounting insert
71 mounting hole
8 wiring insert
9 thermal pad
10 pre-positioning member
101 protrusion
102 positioning hole

Explanation of the reference numerals with parentheses in the accompanying drawings: In the drawings, the features indicated by the reference numerals in brackets correspond to the features represented by the number inside the brackets and those represented by the numbers outside the brackets.

### DETAILED DESCRIPTION

The present disclosure will be further detailed below through specific embodiments with reference to the accompanying drawings. Common or similar elements are referenced with like or identical reference numerals in different embodiments. Many details in the following embodiments are described to facilitate a better understanding of the present application. However, it will be effortlessly recognized by those skilled in the art that some features may be omitted under different circumstances or may be substituted by other components, materials, or methods. For clarity some operations related to the present disclosure are not shown or illustrated herein so as to prevent the core from being overwhelmed by excessive descriptions. For those skilled in the art, such operations are not necessary to be explained in detail, and they can fully understand the related operations according to the description in the specification and the general technical knowledge in the art.

Additionally, the characteristics, operations, or features described in the specification may be combined in any appropriate manner to form various embodiments. At the same time, the steps or actions in the described method can be reordered or adjusted in ways that are obvious to those skilled in the art. Therefore, the various sequences in the specification and drawings are merely for clearly describing a particular embodiment and are not intended to be an order of necessity, unless otherwise stated one of the sequences must be followed.

The serial numbers assigned to components herein, such as “first”, “second”, etc., are used solely for distinguishing the described objects and do not carry any sequential or technical meaning. The terms “connected”, “coupled” and the like here include direct and indirect connections (coupling) unless otherwise specified.

The term “end” herein refers to a portion located at an end of a component with a certain length, and it does not specifically refer to the end face of the component.

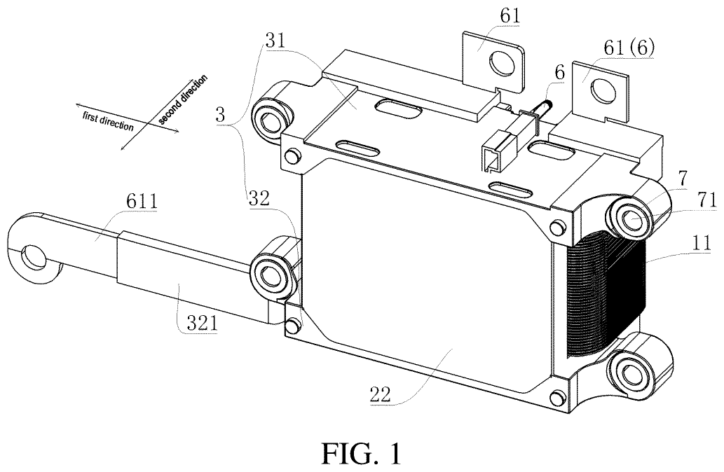

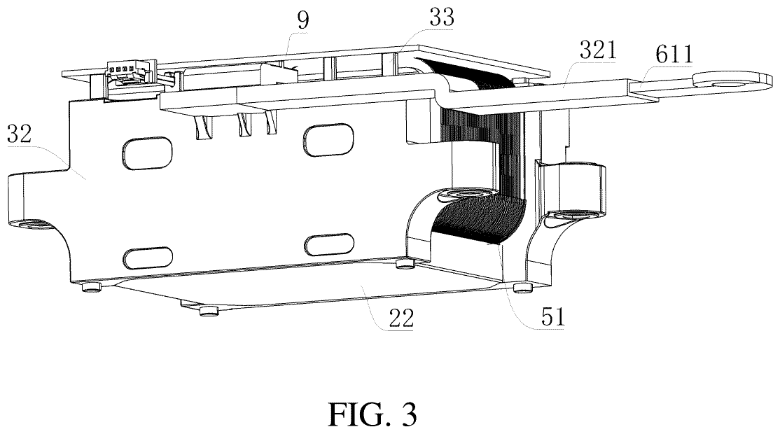

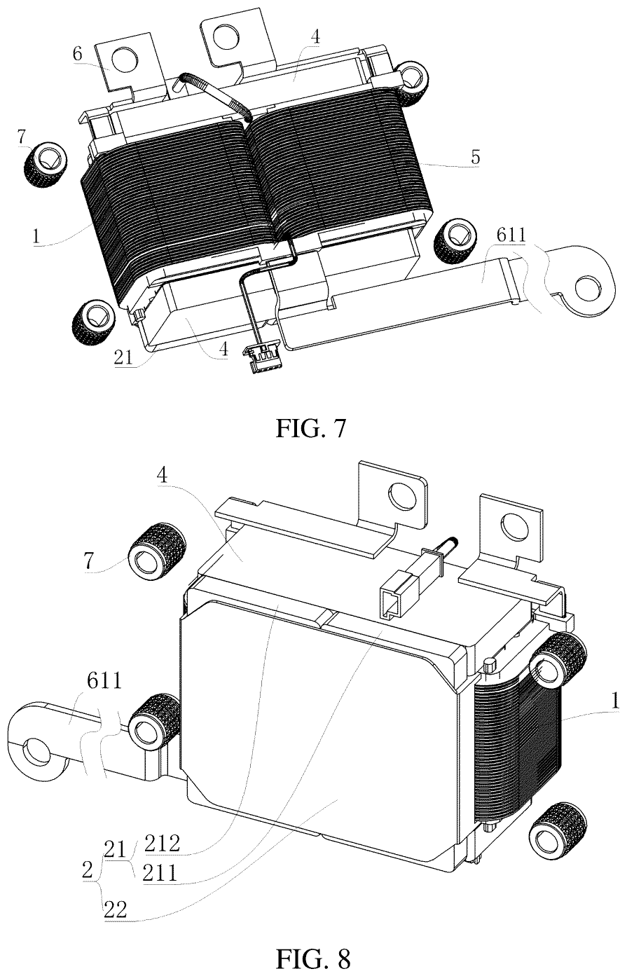

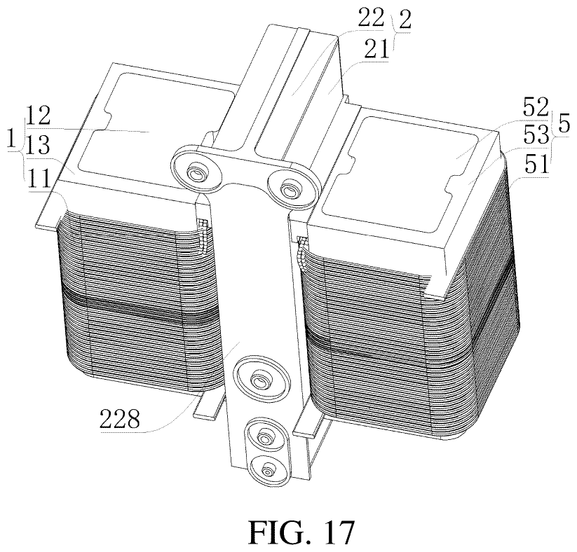

In some embodiments, as shown in FIGS. 1 to 20, an inductor device may include a first assembly 1, a magnetic yoke column assembly 2 and an inductor injection-molded body 3.

As shown in FIGS. 1 to 6 and FIGS. 12 to 15, the first assembly 1 may comprise a first inductor coil 11, a first magnetic core column 12 and a first injection-molded body 13. The first inductor coil 11 may be wound around the outer perimeter of the first magnetic core column 12, with a gap left between the first inductor coil 11 and the first magnetic core column 12. The first injection-molded body 13 may be formed by injection molding over the first inductor coil 11 and the first magnetic core column 12, serving to fix the first inductor coil 11 and the first magnetic core column 12 in place. At least a portion of the first injection-molded body 13 may fill the gap between the first inductor coil 11 and the first magnetic core column 12.

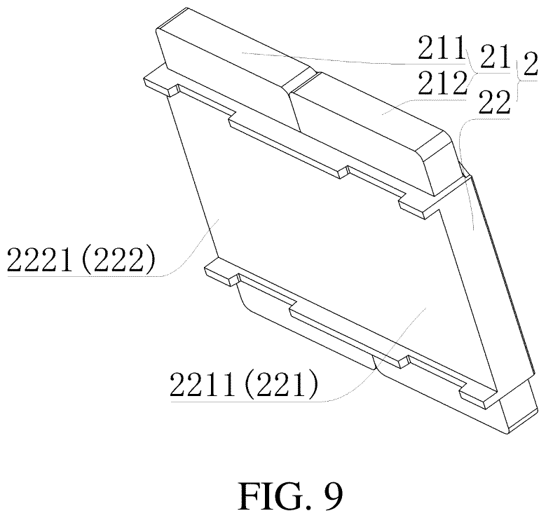

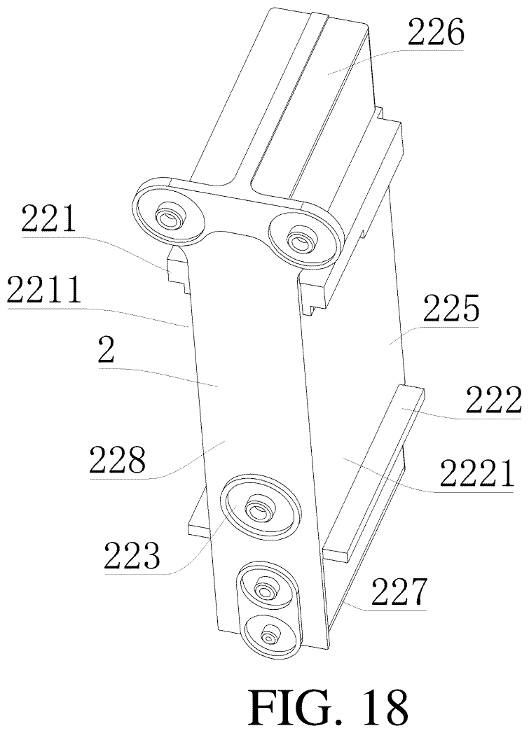

The magnetic yoke column assembly 2 may comprise a magnetic yoke column 21 and a magnetic yoke column injection-molded body 22 that is injection-molded onto the magnetic yoke column 21. The magnetic yoke column injection-molded body 22 may have a first assembly positioning structure 221 for positioning the first assembly 1 (as shown in FIGS. 9, 18). The magnetic yoke column injection-molded body 22 and the first injection-molded body 13 may be injection-molded separately, which is beneficial for reducing the injection pressure during the injection molding process.

The inductor device may further include an end magnetic yoke 4 arranged at an end of the magnetic yoke column 21, with a magnetic circuit between the first magnetic core column 12 and the magnetic yoke column 21 being conducted through the end magnetic yoke 4. The inductor injection-molded body 3 may be formed after the first injection-molded body 13 and the magnetic yoke column injection-molded body 22 are injection-molded, the inductor injection-molded body 3 may fix the first assembly 1 and the magnetic yoke column assembly 2 in place. In some embodiments, the inductor injection-molded body 3 may fix the end magnetic yoke 4, the first assembly 1 and the magnetic yoke column assembly 2 in place.

It should be noted that both the magnetic yoke column 21 and the end magnetic yoke 4 are arranged outside the coil, serving to conduct the magnetic circuit. The extension direction of the magnetic yoke column 21 may be consistent with that of the first magnetic core column 12. The magnetic circuit between the magnetic yoke column 21 and the first magnetic core column 12 may be conducted through the end magnetic yoke 4. The end magnetic yoke 4 may be implemented in any feasible manner, which will be described in detail below.

Regarding the first assembly 1 of the inductor device, the first inductor coil 11 and the first magnetic core column 12 may be fixed in place by injection-molding the first injection-molded body 13, with the first injection-molded body 13 filling the gap between the first inductor coil 11 and the first magnetic core column 12. Regarding the magnetic yoke column assembly 2 of the inductor device, the magnetic yoke column injection-molded body 22 may be injection-molded onto the magnetic yoke column 21, and during the formation of the magnetic yoke column injection-molded body 22, the first assembly positioning structure 221 may be formed simultaneously. In this way, with the first assembly positioning structure 221, the assembly of the first assembly 1 and the magnetic yoke column assembly 2 can be facilitated. The first assembly 1 and the magnetic yoke column assembly 2, which are positioned together, may be secured in place by the inductor injection-molded body 3.

The injection molding bodies involved in the inductor device in the present disclosure are formed through multiple injection stages. Initially, the first inductor coil 11 and the first magnetic core column 12 are fixed together in advance by injection molding. In this way, the injection pressure required for the first injection-molded body 13 can be lower than that for the entire injection molding of the inductor device. As a result, the first magnetic core column 12 can experience less injection pressure, making it less prone to damage and improving the yield of the inductor device. Similarly, the magnetic yoke column 21 can also experience reduced injection pressure. Furthermore, the first assembly positioning structure 221 injection-molded on the magnetic yoke column injection-molded body 22 can facilitate the assembly of the first assembly 1 and the magnetic yoke column assembly 2, thereby enhancing the molding efficiency of the inductor device. When the first assembly 1 and the magnetic yoke column assembly 2 are fixed in place by the inductor injection-molded body 3, due to the first injection-molded body 13 having already fixed the first magnetic core column 12 and the first inductor coil 11, the overall anti-pressure ability of the first assembly 1 is relatively high, enabling it to withstand greater injection pressure, and accordingly, the magnetic yoke column assembly 2 can also endure higher injection pressure, and neither is easily damaged under such pressure, resulting in a higher yield of the molded inductor device.

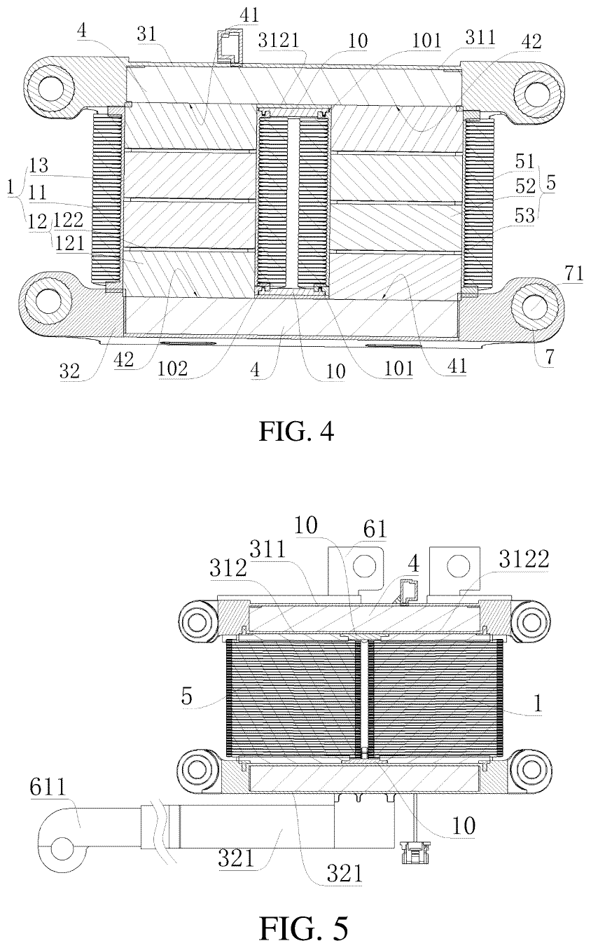

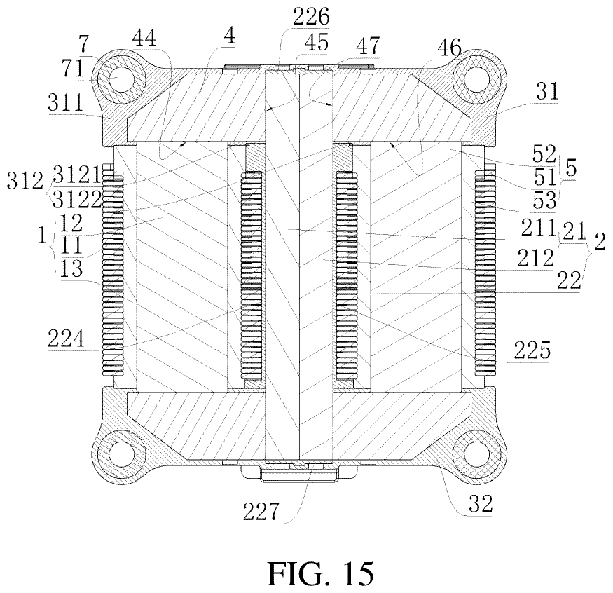

Specifically, in some embodiments, the first injection-molded body 13 is entirely filled by injection into the gap between the first inductor coil 11 and the first magnetic core column 12. In some embodiments, as shown in FIGS. 4 and 15, a part of the first injection-molded body 13 is filled by injection into the gap between the first inductor coil 11 and the first magnetic core column 12, and another part is injection-molded onto the portion where the first magnetic core column 12 extends beyond the first inductor coil 11. In some embodiments, the first injection-molded body 13 may also extend to the outer surface of the first inductor coil 11, thereby covering at least a part of the outer surface of the first inductor coil 11.

Specifically, in some embodiments, the first injection-molded body 13, the magnetic yoke column injection-molded body 22 and the inductor injection-molded body 3 may all be made of any feasible material. Typically, the first injection-molded body 13, the magnetic yoke column injection-molded body 22 and the inductor injection-molded body 3 are all made of insulating materials.

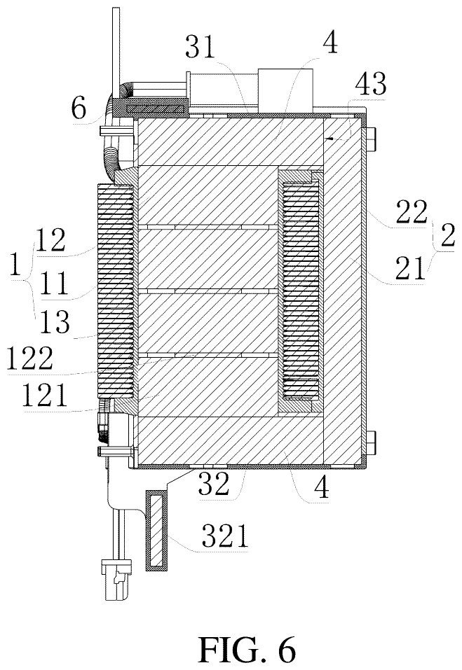

Regarding the first magnetic core column 12, in some embodiments, as shown in FIGS. 4 and 6, the first magnetic core column 12 may comprise at least two stacked magnetic core blocks 121, with a ceramic plate interposed between adjacent magnetic core blocks 121. Specifically, in some embodiments, there may be four magnetic core blocks 121, as well as three ceramic plates 122 made of magnetically conductive ceramic.

Further, in some embodiments, as shown in FIGS. 4 and 15, the inductor device may further comprise a second assembly 5 that may comprise a second inductor coil 51, a second magnetic core column 52 and a second injection-molded body 53. The second inductor coil 51 may be wound around the outer perimeter of the second magnetic core column 52, the second injection-molded body 53 may secure the second inductor coil 51 and the second magnetic core column 52 in place, and at least a portion of the second injection-molded body 53 may fill the gap between the second inductor coil 51 and the second magnetic core column 52. As shown in FIGS. 9 and 18, the magnetic yoke column injection-molded body 22 may be provided with a second assembly positioning structure 222 for positioning the second assembly 5. After the second injection-molded body 53 is injection-molded, the inductor injection-molded body 3 may be formed to fix the first assembly 1, the second assembly 5 and the magnetic yoke column assembly 2 in place. The magnetic circuit between the second magnetic core column 52 and the magnetic yoke column 21 may also be conducted through the end magnetic yoke 4. While the inductor injection-molded body 3 fixes the first assembly 1, the second assembly 5 and the magnetic yoke column assembly 2 in place, it may also secure the end magnetic yoke 4 together.

In some embodiments, the first magnetic core column 12, the second magnetic core column 52 and the magnetic yoke column 21 may be arranged in pairs with parallel spacing between each other.

In some embodiments, as shown in FIG. 4, the first assembly 1 and the second assembly 5 may be arranged symmetrically. The second assembly 5 may be of the same structure as the first assembly 1. In some other embodiments, depending on actual needs, there may require only one of the first assembly 1 and the second assembly 5.

In some embodiments, as shown in FIGS. 8, 9, 17 and 18, the first assembly positioning structure 221 may include a first positioning slot 2211. When the first assembly 1 is assembled with the magnetic yoke column assembly 2, the magnetic yoke column assembly 2 may wedge the first assembly 1 through the first positioning slot 2211, with the bottom surface of the first positioning slot 2211 contacting the surface of the first inductor coil 11 of the first assembly 1. Similarly, in some embodiments, the second assembly positioning structure 222 may comprise a second positioning slot 2221. When the second assembly 5 is assembled with the magnetic yoke column assembly 2, the magnetic yoke column assembly 2 may wedge the second assembly 5 through the second positioning slot 2221. In some other embodiments, apart from the positioning slots, the first assembly positioning structure 221 may also include a positioning block; in this respect, a corresponding positioning slot or positioning hole adapted to the positioning block may be formed on the first injection-molded body 13.

To better illustrate the structure of the inductor device in the present disclosure, the following provides a detailed description of the structure of the inductor device with different embodiments.

In some embodiments, as shown in FIGS. 1 to 11 and 20, the first magnetic core column 12 and the second magnetic core column 52 may be arranged along a first direction. The magnetic yoke column 21 may be arranged in a lateral configuration, meaning that the first magnetic core column 12 and the magnetic yoke column 21 may be arranged along a second direction, where the angle between the first direction and the second direction is greater than 0 degrees. Specifically, in some embodiments, the angle between the first and second directions may be 90 degrees. In some other embodiments, the angle between the first and second directions may be less than 90 degrees.

When the angle between the first and second directions is greater than 0 degrees, the magnetic yoke column 21 is displaced beside either the first magnetic core column 12 or the second magnetic core column 52, which allows for an increase in the magnetic flux area within a limited space.

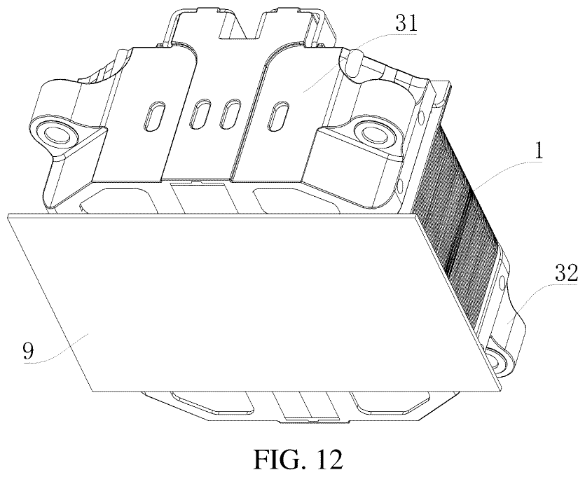

Of course, in some embodiments, as shown in FIGS. 12 to 19, the magnetic yoke column 21 may also be arranged in a position between the first magnetic core column 12 and the second magnetic core column 52.

In some embodiments, as shown in FIG. 9, the magnetic yoke column injection-molded body 22 may be an injection-molded cylinder, and the magnetic yoke column 21 may be flat. The first assembly positioning structure 221 and the second assembly positioning structure 222 may be arranged on the outer side of the wall of the injection-molded cylinder.

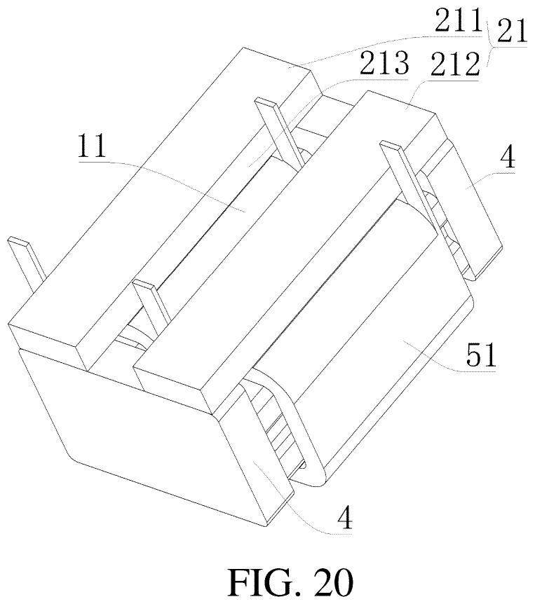

Furthermore, when the magnetic yoke column 21 is arranged in a lateral configuration, in some embodiments, as shown in FIG. 20, the magnetic yoke column 21 may comprise a first column 211 and a second column 212 that are spaced apart along the first direction, and a column spacing 213 may be formed between the first column 211 and the second column 212. The inductor device may comprise an inductor lead wire 6. At least an inductor lead wire 6 and/or a terminal of the first inductor coil 11 and/or a terminal of the second inductor coil 51 may pass through the column spacing 213. The column spacing 213 can facilitate wire routing and allow the magnetic yoke column 21 to be arranged on the same side of the first magnetic core column 12 and the second magnetic core column 52 without affecting the wire routing of the coil. In some embodiments, the inductor lead wire 6 may be either the terminal conducting bar 61 that connects to the coil or a signal wire used for transmitting signals.

Specially, when injection-molding the magnetic yoke column injection-molded body 22 onto the magnetic yoke column 21, the first column 211 and the second column 212 may be injection-mold separately; accordingly, the magnetic yoke column injection-molded body 22 may include a first injection-molded part arranged on the first column 211 and a second injection-molded part arranged on the second column 212. Of course, both the first and second injection-molded parts are formed with the first assembly positioning structure 221 thereon. In some embodiments, both the first and second injection-molded parts may also be formed with the second assembly positioning structure 222 thereon.

In some embodiments, as shown in FIGS. 9 and 15, the first column 211 and the second column 212 may also be attached together; accordingly there is no need for the column spacing 213. In some other embodiments, the magnetic yoke column 21 may be of an integrated structure. In yet some other embodiments, the magnetic yoke column 21 may also be formed by stacking a plurality of magnetic core blocks together.

Specifically, in some embodiments, as shown in FIG. 9, the magnetic yoke column 21 may be flat, which is beneficial for reducing the thickness of the magnetic yoke column 21 and decreasing the volume of the inductor device. As the same time, it also facilitates heat conduction to the magnetic yoke column 21 and subsequent rapid dissipation of heat.

Regarding the end magnetic yoke 4, in some embodiments, as shown in FIGS. 4, 6 and 15, the end magnetic yoke 4 and the magnetic yoke column 21 may be designed as detachable components, and the inductor injection-molded body 3 may fix the end magnetic yoke 4 and the magnetic yoke column 21 together through injection molding. In some other embodiments, the end magnetic yoke 4 and the magnetic yoke column 21 may be designed as an integral structure.

Furthermore, in some embodiments, as shown in FIGS. 4 to 6, the end of the first magnetic core column 12, the end of the second magnetic core column 52 and the end of the magnetic yoke column 21 may all magnetically connected to the end magnetic yoke 4. The end magnetic yoke 4 may include a first magnetic core column conducting surface 41, a second magnetic core column conducting surface 42 and a magnetic yoke column conducting surface 43. The first magnetic core column conducting surface 41 may be perpendicular to the magnetic yoke column conducting surface 43; and the first magnetic core column conducting surface 41 and the second magnetic core column conducting surface 42 may be arranged on the same side of the end magnetic yoke 4. This design allows the end magnetic yoke 4 to closely fit with both the magnetic core columns and the magnetic yoke column 21 through different side surfaces thereof, ensuring a tight fit between the end magnetic yoke 4 and the magnetic yoke column 21, as well as between the end magnetic yoke 4 and the magnetic core columns.

The end magnetic yoke 4 may also be in other arrangements. For example, in some embodiments, as shown in FIG. 15, the first magnetic core column 12 may correspond to two first end magnetic yokes, and the second magnetic core column 52 may correspond to two second end magnetic yokes. The length of the magnetic yoke column 21 may be greater than that of the first magnetic core column 12. A side surface of the first end magnetic yoke may be a first end magnetic yoke surface 44 that fits against the end surface of the first magnetic core column 12, and another side surface may be a second end magnetic yoke surface 45 that fits against the side surface of the magnetic yoke column 21, with the first end magnetic yoke surface 44 being perpendicular to the second end magnetic yoke surface 45.

Similarly, a side surface of the second end magnetic yoke may be a third end magnetic yoke surface 46 that fits against the end surface of the second magnetic core column 52, and another side surface may be a fourth end magnetic yoke surface 47 that fits against the side surface of the magnetic yoke column 21, with the third end magnetic yoke surface 46 being perpendicular to the fourth end magnetic yoke surface 47.

By extending the length of the magnetic yoke column 21, the two end magnetic yokes 4 may be positioned on opposite sides of the same end of the magnetic yoke column 21, thus avoiding the issue where the end surfaces of the magnetic yoke column 21, the first magnetic core column 12 and the second magnetic core column 52 cannot contact the same end magnetic yoke 4 simultaneously during assembly.

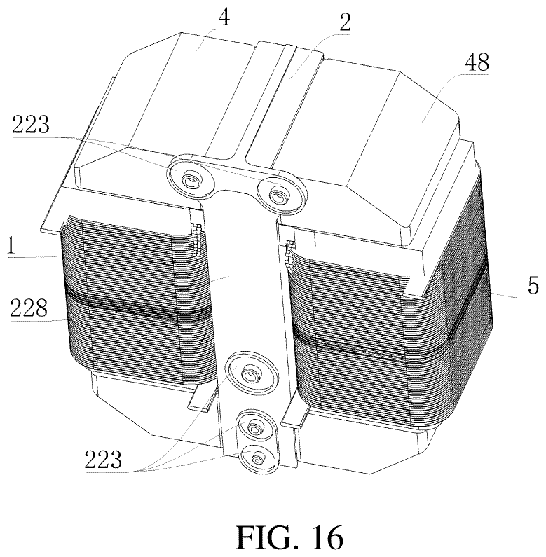

Furthermore, in some embodiments, as shown in FIGS. 15 and 16, the end magnetic yoke 4 may have a chamfer 48. A portion of the inductor injection-molded body 3 located at the chamfer 48 of the end magnetic yoke 4 may be embedded with an mounting insert 7. The mounting insert 7 may have an mounting hole 71 configured to install the inductor device to a target position. This design makes the overall inductor device more compact and occupies less space.

In some embodiments, as shown in FIGS. 15 to 17, the magnetic yoke column 21 may be arranged between the first magnetic core column 12 and the second magnetic core column 52.

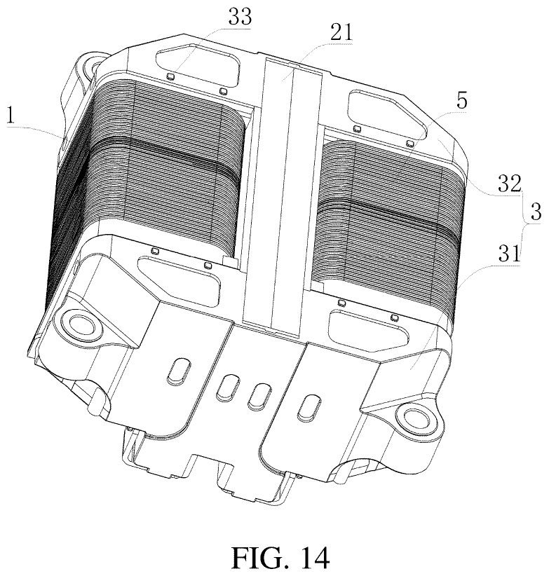

Furthermore, in some embodiments, as shown in FIGS. 14 to 17, the magnetic yoke column injection-molded body 22 may include a first side plate 224, a second side plate 225, a first end plate 226, a second end plate 227 and a base plate 228. The first side plate 224, the second side plate 225, the first end plate 226 and the second end plate 227 may all be connected to the base plate 228. The first side plate 224 may be arranged between the first magnetic core column 12 and the magnetic yoke column 21, the second side plate 225 may be arranged between the second magnetic core column 52 and the magnetic yoke column 21, the first end plate 226 may be arranged between the first inductor injection-molded body 31 and the magnetic yoke column 21, and the second end plate 227 may be arranged between the second inductor injection-molded body 32 and the magnetic yoke column 21. The magnetic yoke column injection-molded body 22 may have an opening opposite to the base plate 228 for facilitating the exposure of the magnetic yoke column 21 (as shown in FIG. 14) for better heat dissipation. The first end plate 226 and the second end plate 227 can prevent the separation of the magnetic yoke column 21 from the magnetic yoke column injection-molded body 22.

Furthermore, in some embodiments, as shown in FIG. 15, the magnetic yoke column 21 may comprise a first column 211 and a second column 212 that are attached together.

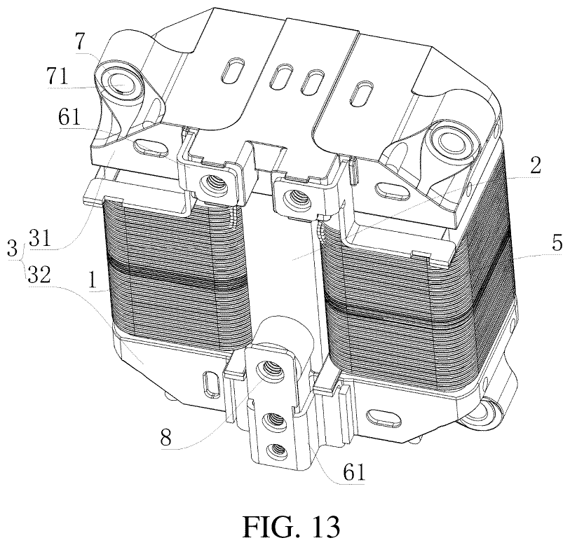

Furthermore, in some embodiments, as shown in FIGS. 13, 16 to 18, the magnetic yoke column injection-molded body 22 may have an insert positioning structure 223 configured to position a wiring insert 8. The inductor injection-molded body 3 may fix the wiring insert 8 and the magnetic yoke column assembly 2 together. The wiring insert 8 may be configured to fix the terminal conducting bar 61 which is conductively connected to the end of the inductor coil. When an external wire is conductively connected to the terminal conducting bar 61, the external wire and the terminal conducting bar 61 may be fixed in place through the cooperation of the wiring insert 8 and a fastener.

Specifically, in some embodiments, as shown in FIGS. 16 to 18, the insert positioning structure 223 is an insert positioning slot for positioning and inserting the wiring insert 8. After the injection molding of the magnetic yoke column injection-molded body 22 is completed, the wiring insert 8 is positioned with the magnetic yoke column injection-molded body 22 through the insert positioning slot, and then the inductor injection-molded body 3 may be formed by injection molding, fixing the wiring insert 8 through the inductor injection-molded body 3.

Furthermore, in some embodiments, as shown in FIGS. 4, 5 and 10, when the magnetic yoke column 21 is arranged in a lateral configuration, in order to facilitate the installation of the first assembly 1 and the second assembly 5, the inductor device may comprise a pre-positioning member 10. Before the inductor injection-molded body 3 fixes the first assembly 1 and the second assembly 5 in place, the pre-positioning member 10 may pre-position the first assembly 1 and the second assembly 5.

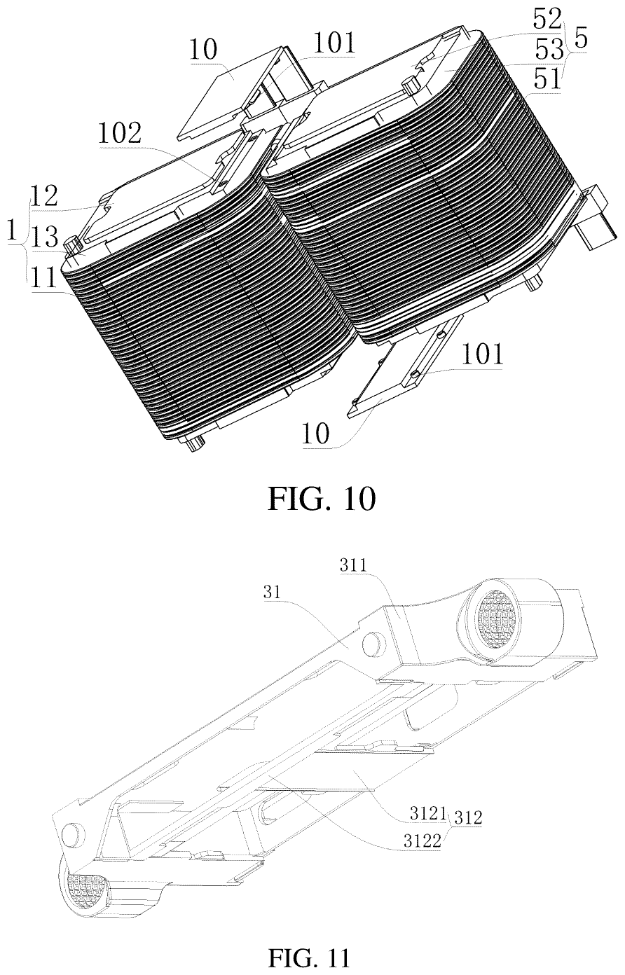

Specifically, in some embodiments, as shown in FIGS. 4 and 10, the pre-positioning member 10 may be a positioning plate with a protrusion 101 thereon. The first assembly 1 and the second assembly 5 each may be provided a positioning hole 102 for the protrusion 101 to insert into. After the protrusion 101 is inserted into the positioning hole 102, the positioning plate may pre-position and connect the first assembly 1 and the second assembly 5 together, facilitating the assembly of the magnetic yoke column assembly 2 with the first assembly 1 and the second assembly 5. Furthermore, there may be two positioning plates, each positioned at the two ends of the first assembly 1 in the extension direction of the first magnetic core column 12. The positioning protrusion 101 may be located on the opposite side of the two positioning plates. Regarding the position of the positioning plate, it may be arranged at an end of the first assembly 1, specifically on the side where the first assembly 1 and the second assembly 5 are close to each other. During installation, the protrusion 101 may be inserted into the positioning hole 102 along the extension direction of the first magnetic core column 12.

Specifically, as shown in FIGS. 4 and 10, the positioning hole 102 of the first assembly 1 may be arranged on the first injection-molded body 13, and the positioning hole 102 of the second assembly 5 may be arranged on the second injection-molded body 53.

Furthermore, in some embodiments, as shown in FIGS. 1 and 6, a side of the first inductor coil 11 facing the magnetic yoke column 21 and a side of the second inductor coil 51 facing the magnetic yoke column 21 may both be in contact with the magnetic yoke column injection-molded body 22; additionally, a side of the first inductor coil 11 facing away from the magnetic yoke column 21 and a side of the second inductor coil 51 facing away from the magnetic yoke column 21 may both be heat dissipation surfaces designed to be in contact with a thermal pad 9.

In this way, the side of the first inductor coil 11 that is in contact with the magnetic yoke column injection-molded body 22 can dissipate heat through the magnetic yoke column 21, while the side of the first inductor coil 11 facing away from the magnetic yoke column 21 can dissipate heat through the thermal pad 9. Similarly, the second inductor coil 51 can also dissipate heat through the magnetic yoke column 21 and the thermal pad 9; as such, the inductor device can exhibit good heat dissipation performance.

Specifically, as shown in FIGS. 8 and 9, when the magnetic yoke column 21 is arranged in a lateral configuration, the magnetic yoke column 21 may be in a flattened shape, which is more conducive to increasing the heat dissipation area.

Furthermore, in some embodiments, as shown in FIGS. 12 and 15, the side of the first inductor coil 11 facing the magnetic yoke column 21 and the side of the second inductor coil 51 facing the magnetic yoke column 21 may be both in contact with the magnetic yoke column injection-molded body 22. A side of the first inductor coil 11 and a side of the second inductor coil 51 may both be heat dissipation surfaces designed to be in contact with the thermal pad 9.

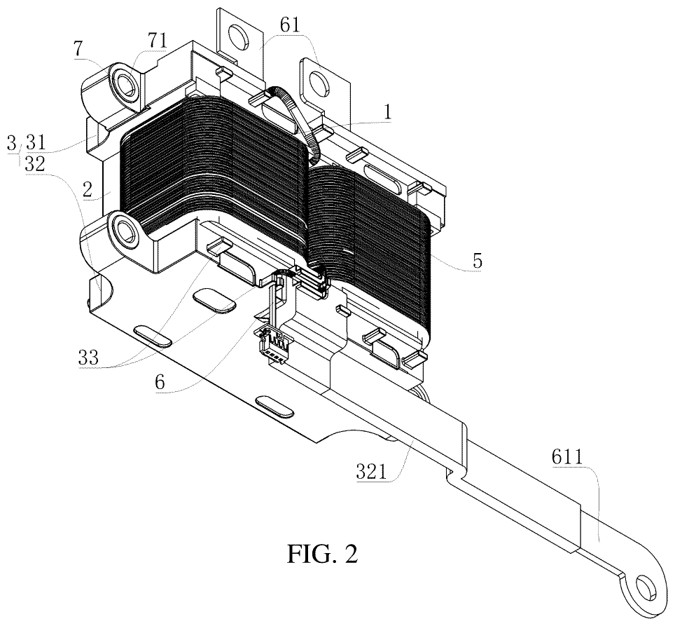

Furthermore, in some embodiments, as shown in FIGS. 2, 6, 13 and 15, the inductor injection-molded body 3 may include the first inductor injection-molded body 31 and the second inductor injection-molded body 32. The first inductor injection-molded body 31 and the second inductor injection-molded body 32 may be spaced apart in the extension direction of the magnetic yoke column 21. The first inductor injection-molded body 31 may be injection-molded at one end of the magnetic yoke column 21, and the second inductor injection-molded body 32 may be injection-molded at the other end of the magnetic yoke column 21.

In this way, the inductor injection-molded body 3 can cover a smaller area, allowing a larger portion of the coil to be exposed, which enables the inductor device to have better heat dissipation performance.

In some embodiments, as shown in FIGS. 1 and 2, the terminal conducting bar 61 of the inductor device may all be led out from the first inductor injection-molded body 31 and the second inductor injection-molded body 32. This design allows the side of the magnetic yoke column assembly 2 facing away from the first inductor coil 11 to be a flat surface that can be in contact with the thermal pad 9. At the same time, the side of the first inductor coil 11 facing away from the magnetic yoke column 21 and the side of the second inductor coil 51 facing away from the magnetic yoke column 21 may both be flat surfaces that can be in contact with the thermal pad 9. Accordingly, the inductor device can utilize two parallel thermal pads 9 for heat dissipation, resulting in better heat dissipation capability. Of course, the heat dissipation surfaces described herein that can contact the thermal pad 9 can also dissipate heat externally when the thermal pad 9 is not used.

In some embodiments, as shown in FIGS. 1 to 3 and 12 to 14, to ensure the stability of the relative position between the thermal pad 9 and the coil, the inductor injection-molded body 3 has extrusion protrusions 33. After the coil comes into contact with the thermal pad 9, the extrusion protrusions 33 can press against the thermal pad 9, forming indentations on the thermal pad 9. The extrusion protrusions 33 may extend into the indentations, effectively restricting the movement of the thermal pad 9 and ensuring that the thermal pad 9 does not easily shift relative to the coil.

Furthermore, in some embodiments, as shown in FIGS. 1, 2, 5 and 6, the inductor lead wire 6 of the inductor device may include a terminal conducting bar 61. To enhance the stability of the terminal conducting bar 61, the terminal conducting bar 61 may include a first terminal conducting bar 611 connected to the first inductor coil 11, and the inductor injection-molded body 3 may include a conducting bar injection-molded part 321 that is injection-molded onto the first terminal conducting bar 611. This design can increase the strength of the first terminal conducting bar 611, making it less prone to shaking and less likely to be bent or deformed. Especially for the terminal conducting bar 61 with a special structure, such as when the first terminal conducting bar 611 needs to be extended to a longer length due to installation requirements, it is fixed in place by injection molding with the inductor injection-molded body 3 along the first terminal conducting bar 611, thereby enhancing the stability of the first terminal conducting bar 611. In some embodiments, the first terminal conducting bar 611 may be connected to the second inductor coil 51 simultaneously.

In some embodiments, as shown in FIGS. 4, 5, 11, 15 and 19, the first inductor injection-molded body 31 may be injection-molded onto the end of the magnetic yoke column 21. To enhance the stability of the first inductor injection-molded body 31, the first inductor injection-molded body 31 may include a surface portion 311 that covers the outer surface of the end magnetic yoke 4 and an inner portion 312 arranged on the side of the end magnetic yoke 4 facing the first magnetic core column 12. The inner portion 312 may be connected onto the surface portion 311. In the extension direction of the first magnetic core column 12, at least a part of the inner portion 312 may be arranged between the first injection-molded body 13 and the end magnetic yoke 4. The inner portion 312 is able to better restrict the separation of the first inductor injection-molded body 31 from the end magnetic yoke 4.

In some embodiments, as shown in FIGS. 4, 5 and 11, there are two inner portions 312, namely a first inner portion 3121 and a second inner portion 3122. In the direction of the arrangement of the first magnetic core column 12 and the second magnetic core column 52, the first inner portion 3121 is arranged between the first magnetic core column 12 and the second magnetic core column 52. In the direction of the arrangement of the magnetic yoke column 21 and the first magnetic core column 12, the second inner portion 3122 is arranged on the side of the magnetic yoke column 21 facing the first magnetic core column 12, with both ends of the second inner portion 3122 connected to the surface portion 311. One end of the first inner portion 3121 is connected to the second inner portion 3122, while the other end is connected to the surface portion 311.

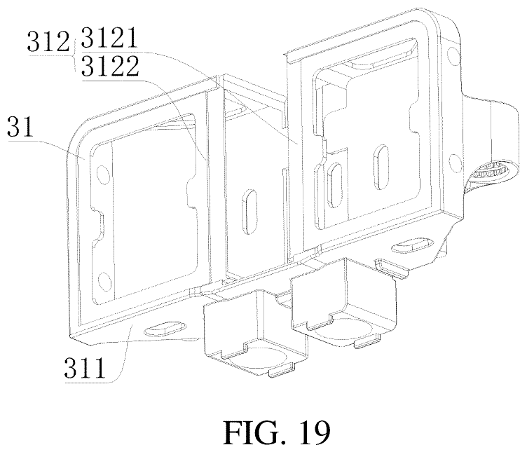

In some other embodiments, as shown in FIGS. 15 and 19, the inner portion 312 may comprise the first inner portion 3121 and the second inner portion 3122 that are arrange on opposite sides of the magnetic yoke column 21. In the direction of the arrangement of the first magnetic core column 12 and the second magnetic core column 52, the first inner portion 3121 is arranged between the first magnetic core column 12 and the magnetic yoke column 21, and the second inner portion 3122 is arranged between the second magnetic core column 52 and the magnetic yoke column 21. In the extension direction of the first magnetic core column 12, a part of the first inner portion 3121 is arranged between the end magnetic yoke 4 and the first injection-molded body 13, and another part of it is arranged between the end magnetic yoke 4 and the end face of the magnetic yoke column injection-molded body 22. Similarly, a part of the second inner portion 3122 is arranged between the end magnetic yoke 4 and the second injection-molded body 53, and another part of it is arranged between the end magnetic yoke 4 and the end face of the magnetic yoke column injection-molded body.

In some embodiments, the structure of the second inductor injection-molded body 32 is similar to that of the first inductor injection-molded body 31, and accordingly, detailed description will not be repeated here.

In some embodiments, the magnetic yoke column 21 is parallel to the first magnetic core column 12. The magnetic yoke column 21 is also parallel to the second magnetic core column 52.

In some embodiments, as shown in FIGS. 1 to 20, the steps of the forming method for the inductor device may include:
winding the first inductor coil 11 of the inductor device around the outer perimeter of the first magnetic core column 12, fixing the first magnetic core column 12 and the first inductor coil 11 in place by injection-molding the first injection-molded body 13, and filling at least a part of the first injection-molded body 13 into the gap between the first magnetic core column 12 and the first inductor coil 11 to prepare the first assembly 1;

Injection-molding the magnetic yoke column injection-molded body 22 onto the magnetic yoke column 21 of the inductor device, and forming the first assembly positioning structure 221 on the magnetic yoke column injection-molded body 22 to prepare the magnetic yoke column assembly 2; and
positioning and assembling the first assembly 1 and the magnetic yoke column assembly 2 to align the first assembly 1 with the first assembly positioning structure 221, and fixing the first assembly 1 and the magnetic yoke column assembly 2 together by injection-molding the inductor injection-molded body 3.

Furthermore, the steps of the forming method for the inductor device may also include: winding the second inductor coil 51 of the inductor device around the outer perimeter of the second magnetic core column 52, fixing the second magnetic core column 52 and the second inductor coil 51 in place by injection-molding the second injection-molded body 53, and filling at least a part of the second injection-molded body 53 into the gap between the second magnetic core column 52 and the second inductor coil 51 to prepare the second assembly 5. The preparation steps for the magnetic yoke column assembly 2 may also include: forming the second assembly positioning structure 222 on the magnetic yoke column injection-molded body 22. Before injection-molding the inductor injection-molded body 3, the method may further include: positioning and assembling the second assembly 5 and the magnetic yoke column assembly 2 to align the second assembly 5 with the second assembly positioning structure 222; and when injection-molding the inductor injection-molded body 3, the first assembly 1, the second assembly 5, and the magnetic yoke column assembly 2 may be fixed together.

In some embodiments, the injection pressure applied during injection-molding the inductor injection-molded body 3 may be greater than that applied during injection-molding the first injection-molded body 13, greater than that applied during injection-molding the second injection-molded body 53, and greater than that applied during injection-molding the magnetic yoke column injection-molded body 22. In some other embodiments, the injection pressures for different injection-molded bodies can be set as needed. For example, the injection pressure applied during injection-molding the inductor injection-molded body 3 may be less than or equal to that applied during injection-molding the first injection-molded body 13. The injection pressure applied during injection-molding the inductor injection-molded body 3 may also be less than or equal to that applied during injection-molding the second injection-molded body 53. The injection pressure applied during the injection molding of the inductor injection-molded body 3 may also be less than or equal to that applied during injection molding the magnetic yoke column injection-molded body 22.

Specifically, as shown in FIGS. 1 to 11, in some embodiments, the steps of the forming method for the inductor device may be detailed as follows:
positioning and assembling the first inductor coil 11 and the first magnetic core column 12 in an injection mold for performing injection molding to form the first assembly 1, wherein the structure of the first assembly 1 has been introduced in detail above, so it will not be repeated here, and the second assembly 5 may be formed in the same way;
positioning and placing the magnetic yoke column 21 into the injection mold, and injection-molding the magnetic yoke column injection-molded body 22 onto the magnetic yoke column 21 to form the magnetic yoke column assembly 2; and
assembling the terminal conducting bar 61, positioning and placing the first assembly 1, the second assembly 5, the magnetic yoke column assembly 2, the end magnetic yoke 4 and the insert into the injection mold for injection molding, such that the aforementioned components can be fixed together by the inductor injection-molded body 3 that covers a part of the terminal conducting bar 61, forming the main body of the inductor device, and then assembling the remaining inductor lead wire 6.

Specifically, as shown in FIGS. 12 to 19, in some other embodiments, the steps of the forming method for the inductor device may be detailed as follows:
positioning and assembling the first inductor coil 11 and the first magnetic core column 12 in an injection mold for performing injection molding to form the first assembly 1, wherein the structure of the first assembly 1 has been introduced in detail above, so it will not be repeated here, and the second assembly 5 may be formed in the same way;
positioning and placing the magnetic yoke column 21 into the injection mold, and injection-molding the magnetic yoke column injection-molded body 22 onto the magnetic yoke column 21 to form the magnetic yoke column assembly 2; and
positioning and placing the first assembly 1, the second assembly 5, the magnetic yoke column assembly 2, the end magnetic yoke 4 and the insert into the injection mold for injection molding, such that the aforementioned components can be fixed together by the inductor injection-molded body 3 that covers a part of the terminal conducting bar 61, forming the main body of the inductor device, and assembling the terminal conducting bar 61 and the remaining inductor lead wire 6.

In some embodiments, the inductor device may be a high-power inductor, which can be applied to automobiles, such as being used in high-power voltage conversion circuits. Specifically, in some embodiments, the inductor device may be an interleaved boost inductor.

The specific examples provided above are used to illustrate the present disclosure solely for the purpose of facilitating understanding and are not intended to limit the scope of the present disclosure. For those skilled in the art, several simple deductions, modifications or substitutions to the aforementioned specific embodiments can be made based on the principles of this present application.

What is claimed is:

1. An inductor device, comprising:
a first assembly comprising a first inductor coil, a first magnetic core column and a first injection-molded body, with the first inductor coil wound around an outer perimeter of the first magnetic core column, the first inductor coil and the first magnetic core column being secured in place by the first injection-molded body, and at least a part of the first injection-molded body filling a gap between the first inductor coil and the first magnetic core column;
a magnetic yoke column assembly comprising a magnetic yoke column and a magnetic yoke column injection-molded body that is injection-molded onto the magnetic yoke column, with the magnetic yoke column injection-molded body having a first assembly positioning structure for positioning the first assembly;
an inductor injection-molded body, and
an end magnetic yoke arranged at an end of the magnetic yoke column,
wherein a magnetic circuit between the first magnetic core column and the magnetic yoke column is conducted through the end magnetic yoke; the inductor injection-molded body is formed after the first injection-molded body and the magnetic yoke column injection-molded body are injection-molded, and the inductor injection-molded body fixes the first assembly and the magnetic yoke column assembly in place.

2. The inductor device according to claim 1, further comprising a second assembly comprising a second inductor coil, a second magnetic core column and a second injection-molded body, with the second inductor coil wound around an outer perimeter of the second magnetic core column, the second inductor coil and the second magnetic core column being secured in place by the second injection-molded body, and at least a part of the second injection-molded body filling a gap between the second inductor coil and the second magnetic core column;
wherein the magnetic yoke column injection-molded body has a second assembly positioning structure for positioning the second assembly; the inductor injection-molded body is formed after the second injection-molded body is injection-molded, and the inductor injection-molded body fixes the first assembly, the second assembly and the magnetic yoke column assembly in place.

3. The inductor device according to claim 2, wherein the first magnetic core column and the second magnetic core column are arranged along a first direction, and the first magnetic core column and the magnetic yoke column are arranged along a second direction, with an angle between the first direction and the second direction being greater than 0 degrees.

4. The inductor device according to claim 3, wherein an end of the first magnetic core column, an end of the second magnetic core column and an end of the magnetic yoke column are all magnetically connected to the end magnetic yoke; and the end magnetic yoke comprises a first magnetic core column conducting surface, a second magnetic core column conducting surface and a magnetic yoke column conducting surface, with the first magnetic core column conducting surface being perpendicular to the magnetic yoke column conducting surface, and the first magnetic core column conducting surface and the second magnetic core column conducting surface being arranged at a same side of the end magnetic yoke.

5. The inductor device according to claim 3, wherein the inductor device comprises a pre-positioning member; and before the inductor injection-molded body fixes the first assembly and the second assembly, the pre-positioning member pre-positions the first assembly and the second assembly.

6. The inductor device according to claim 1, wherein the inductor injection-molded body comprises a first inductor injection-molded body and a second inductor injection-molded body that are spaced apart along an extension direction of the magnetic yoke column, with the first inductor injection-molded body being injection-molded on one end of the magnetic yoke column and the second inductor injection-molded body on another end of the magnetic yoke column.

7. The inductor device according to claim 6, wherein the first inductor injection-molded body comprises a surface portion covering an outer surface of the end magnetic yoke and an inner portion arranged at a side of the end magnetic yoke facing the first magnetic core column, with the inner portion being connected onto the surface portion; and in an extension direction of the first magnetic core column, at least a part of the inner portion is arranged between the first injection-molded body and the end magnetic yoke.

8. The inductor device according to claim 1, further comprising a first terminal conducting bar connected to the first inductor coil, with a part of the inductor injection-molded body being injection-molded onto the first terminal conducting bar.

9. A forming method for an inductor device, comprising:
winding a first inductor coil of an inductor device around an outer perimeter of a first magnetic core column, fixing the first magnetic core column and the first inductor coil in place by injection-molding a first injection-molded body, and filling at least a part of the first injection-molded body into a gap between the first magnetic core column and the first inductor coil to prepare a first assembly;
injection-molding a magnetic yoke column injection-molded body on a magnetic yoke column of the inductor device, and forming a first assembly positioning structure on the magnetic yoke column injection-molded body to prepare a magnetic yoke column assembly; and
positioning and assembling the first assembly and the magnetic yoke column assembly to position the first assembly and the first assembly positioning structure, and fixing the first assembly and the magnetic yoke column assembly together by injection-molding an inductor injection-molded body.

10. The forming method for an inductor device according to claim 9, further comprising:
winding a second inductor coil of the inductor device around an outer perimeter of a second magnetic core column, fixing the second magnetic core column and the second inductor coil in place by injection-molding a second injection-molded body, and filling at least a part of the second injection-molded body into a gap between the second magnetic core column and the second inductor coil to prepare a second assembly;
wherein the preparation of the magnetic yoke column assembly further comprises: forming a second assembly positioning structure on the magnetic yoke column injection-molded body;
before injection-molding the inductor injection-molded body, the method further comprises: positioning and assembling the second assembly and the magnetic yoke column assembly to position the second assembly and the second assembly positioning structure; and
after injection-molding the inductor injection-molded body, the first assembly, the second assembly and the magnetic yoke column assembly are fixed together by the inductor injection-molded body.
